(19) United States
(12) Patent Application Publication
(10) Pub. No.: US 2009/0094358 A1
(43) Pub. Date: Apr. 9, 2009

(54) Data Bridge Maintenance Utilizing Data Traffic Log Change

(76) Inventor: Gregg A. Davis, Raleigh, NC (US)

Correspondence Address: DILLON & YUDELL LLP, 8911 N. CAPITAL OF TEXAS HWY.,, SUITE 2110, AUSTIN, TX, 78759, US

(21) Appl. No.: 11/868,180

(22) Filed: Oct. 5, 2007

(51) Int. Cl. G06F 15/173

(52) U.S. Cl. 709/224

(57) ABSTRACT

Data traffic, through a data bridge that couples two entities, is monitored and logged in a data traffic log. If the size of the data traffic log does not change within a pre-determined period of time, the data bridge is automatically reset.

### BACKGROUND OF THE INVENTION

The present disclosure relates to the field of computers, and specifically to software. Still more specifically, the present disclosure relates to managing a data bridge between two entities.

Data can be communicated between two entities via a data bridge. Two exemplary entities are a service provider and a service customer. A problem with such communication arises when the data bridge or one of the entities fails, the data sender does not know about the failure until a message is sent from the receiver.

### BRIEF SUMMARY OF THE INVENTION

Data traffic, through a data bridge that couples two entities, is monitored and logged in a data traffic log. If the size of the data traffic log does not change within a predetermined period of time, the data bridge is automatically reset by a data bridge reset logic.

The above as well as additional objectives, features, and advantages of the present invention will become apparent in the following detailed written description.

### BRIEF DESCRIPTION OF THE SEVERAL VIEWS OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts an exemplary computer in which the present invention may be implemented;

FIG. 2 illustrates a data bridge being monitored by a data traffic monitor; and

FIG. 3 is a high-level flow-chart of exemplary steps taken to automatically reset the data bridge shown in FIG. 2 if data fails to pass through the data bridge for a pre-determined period of time.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatuses (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

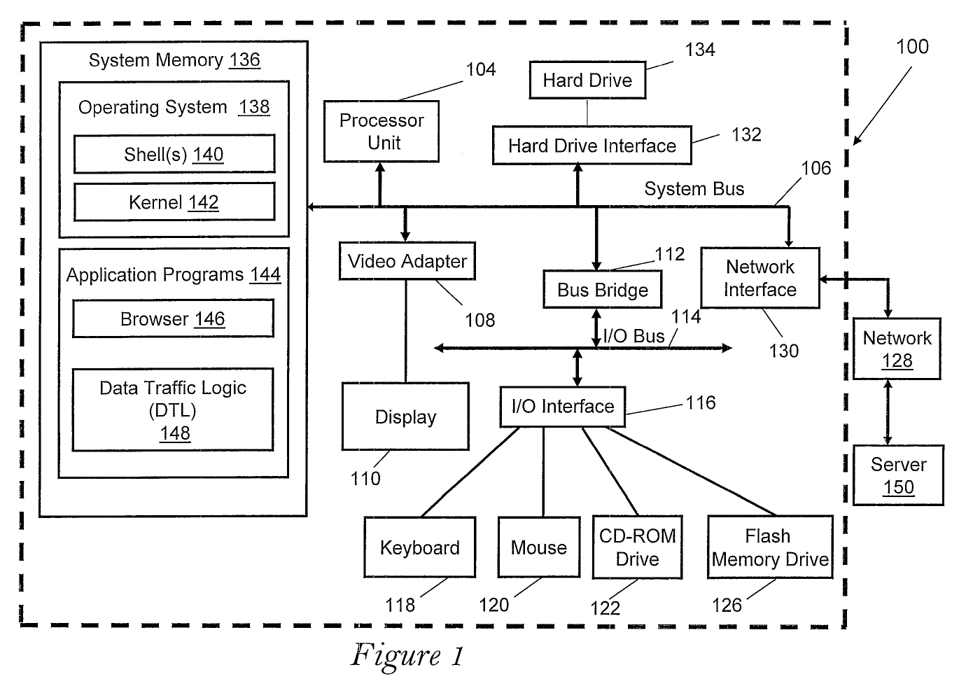

With reference now to FIG. 1, there is depicted a block diagram of an exemplary computer 100, with which the present invention may be utilized. Computer 100 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk-Read Only Memory (CD-ROM) drive 122, and a flash memory drive 126. The format of the ports connected to I/O interface 116 may be any known to those skilled in the art of computer architecture, including but not limited to Universal Serial Bus (USB) ports.

Computer 100 is able to communicate with a server 150 via a network 128 using a network interface 130, which is coupled to system bus 106. Network 128 may be an external network such as the Internet, or an internal network such as an Ethernet or a Virtual Private Network (VPN).

A hard drive interface 132 is also coupled to system bus 106. Hard drive interface 132 interfaces with a hard drive 134. In one embodiment, hard drive 134 populates a system memory 136, which is also coupled to system bus 106. System memory 136 is defined as a lowest level of volatile memory in computer 100. This volatile memory may include additional higher levels of volatile memory (not shown), including, but not limited to, cache memory, registers, and buffers. Code that populates system memory 136 includes an operating system (OS) 138 and application programs 144.

OS 138 includes a shell 140, for providing transparent user access to resources such as application programs 144. Generally, shell 140 (as it is called in UNIX®) is a program that provides an interpreter and an interface between the user and the operating system. Shell 140 provides a system prompt, interprets commands entered by keyboard 118, mouse 120, or other user input media, and sends the interpreted command(s) to the appropriate lower levels of the operating system (e.g., kernel 142) for processing. As depicted, OS 138 also includes kernel 142, which includes lower levels of functionality for OS 138. Kernel 142 provides essential services required by other parts of OS 138 and application programs 144. The services provided by kernel 142 include memory management, process and task management, disk management, and I/O device management. Note that UNIX is merely an exemplary OS that can be utilized by the presently described computer 100, which may utilize any other appropriate OS, including, but not limited to, Windows®, Linux®, etc.

Application programs 144 include a browser 146. Browser 146 includes program modules and instructions enabling a World Wide Web (WWW) client (i.e., computer 100) to send and receive network messages to the Internet. Computer 100 may utilize HyperText Transfer Protocol (HTTP) messaging to enable communication with server 150. Application programs 144 in system memory 136 also include a Data Traffic Logic (DTL) 148. DTL 148 is software that performs the functions described in the figures below, including monitoring data traffic through a data bridge, and resetting that data bridge if no data is throughput for a pre-determined period of time.

The hardware elements depicted in computer 100 are not intended to be exhaustive, but rather represent and/or highlight certain components that may be utilized to practice the present invention. For instance, computer 100 may include alternate memory storage devices such as magnetic cassettes, Digital Versatile Disks (DVDs), Bernoulli cartridges, and the like. These and other variations are intended to be within the spirit and scope of the present invention.

Note that the hardware architecture depicted for computer 100 may be utilized by other hardware components, including, but not limited to, entity 202, entity 204, data bridge 206, data traffic monitor 208, and data bridge reset logic 212. The functionality of these other hardware components may be met by different computer systems (using an architecture that is substantially similar to that described for computer 100), or their functionality may be combined into one or more computer systems.

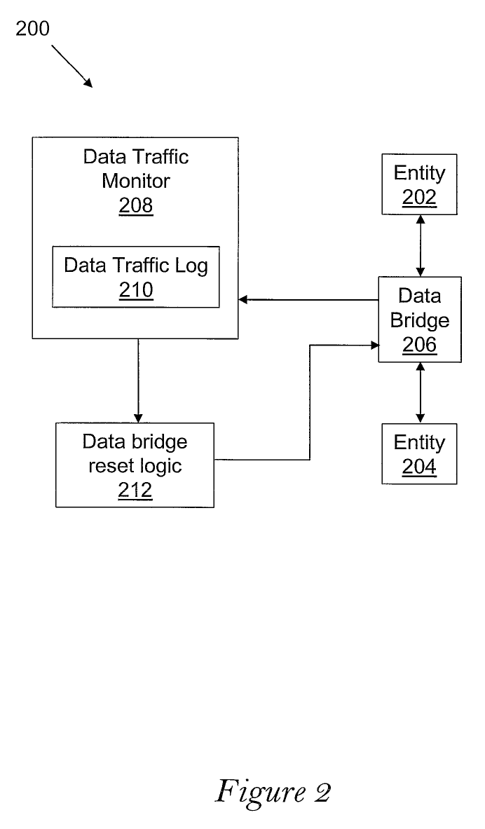

With reference now to FIG. 2, an overview of a data transmission system 200 is presented. An entity 202 and an entity 204 transmit data between themselves via a data bridge 206. Note that these entities 202 and 204 may be different software applications, different computer hardware systems, a customer and a client, etc. In one embodiment, data bridge 206 is a File Transfer Protocol (FTP) device, which only communicates data that conforms to the FTP. Coupled to and monitoring the data bridge 206 is a data traffic monitor 208, which includes a data traffic log 210. The data traffic log 210 records both events (i.e., “data is passing through the data bridge 206) as well as the passing data itself. Thus, as traffic is being passed through the data bridge 206, the data traffic log 210 will naturally grow in size. If there is no data being passed through the data bridge 206 for some pre-determined period of time, then there is an assumption that there is a data bridge hanging (i.e., no data is able to pass between the two entities 202 and 204). If the size of the data traffic log 210 remains constant during the pre-determined period of time, then a signal is sent to a data bridge reset logic 212 to reset the data bridge 206. Data bridge reset logic 212 may be software, a computer system, or a simple reset-switch coupled to the data bridge 206. Note that in one embodiment, a shrinkage of the data traffic log 210 is viewed as normal, and thus there is no need to reset the data bridge 206. For example, occasionally the data traffic log 210 is “pruned back,” in order to avoid it becoming unmanageably large. The present invention considers this to be nominal, and thus a reset of the data bridge 206 is prevented when the data traffic log 210 shrinks in size.

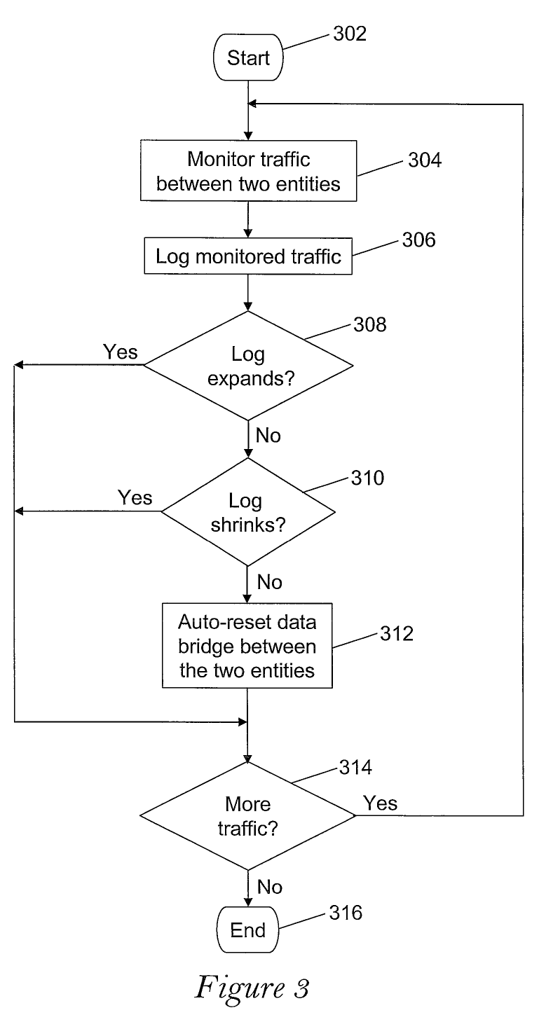

Referring now to FIG. 3, a high-level flow-chart of exemplary steps taken to manage a data bridge is presented. After initiator block 302, traffic between two entities is monitored (block 304). This traffic is logged into a data traffic log by a traffic monitor (block 306). For example, each packet is detected as an event (which is logged), and the contents of the packet may also be logged in the data traffic log. If the data traffic log expands (query block 308) or shrinks (query block 310), this is considered normal, and the data bridge is affirmatively allowed to continue to operate as configured. That is, a reset to the data bridge is actively blocked by the data traffic monitor 208 shown in FIG. 2. However, if the size of the data traffic log remains constant for some pre-determined period of time (e.g., between one and five minutes), then the data bridge is automatically reset to enable data to re-flow between the two entities (block 312). The process continues in an iterative manner until the data trafficking session between the two entities ends (query block 314 and terminator block 316).

An exemplary process and system described above is referred to as a “NoGrowthResponder.” Details for such a “NoGrowthResponder” are described below.

### Prerequisites

NoGrowthResponder requires the following:

1) Java™ 2 1.3 runtime or greater installed on the server of the file to be monitored. The java command needs to be in the PATH system environment variable.

2) A batch file to call the Java application (see “A batch file to start NoGrowtbResponder” below).

3) A batch file for the application to invoke when there is no file growth for the interval (see “A batch file to invoke when the monitored file does not grow as expected” below).

4) The NoGrowthResponder.class file in the same folder as the batch file that starts NoGrowthResponder. This assumes the CLASSPATH system environment variable value starts with a period and semicolon separator (.;) indicating the current folder.

5) An appropriate .properties file configured for the desired operation in the same folder as the class file (see “The .properties file” below).

### NoGrowthResponder Application

### Description

The name NoGrowthResponder stands for No (File) Growth Responder. It detects when a log file is not growing as expected (within the specified interval) and responds by invoking the specified batch command if it is not. NoGrowthResponder automates stopping and restarting a Windows service running a bridge using FTP if the bridge log is not growing as expected (indicating a “hung” FTP condition.)

If the monitored file shrinks in size due to pruning or removal, the program logs the event and continues in one interval using the new size as a baseline for measuring growth. So, the program does not respond by invoking the batch command if the file is either growing or shrinking within the specified interval, or if the file does not exist. It responds and invokes the specified batch command only if the file exists and remains a constant size for the specified interval.

The .properties File

The .properties file is used for setting the application variables. It can be named anything, but must contain the variable values listed below and must be passed to the application at invocation (for example: java NoGrowthResponder IBMLogFileMonitor.properties). In this way, multiple instances of the application may be executed while each performs a different function or monitors a different file for growth. Since the properties are read at the beginning of each execution cycle, the values may be changed while the program is executing to change its behavior for the next execution cycle. Briefly, the variables are as follows:

1) file=The full path and filename to be monitored for continual growth within the interval specified (intervalInSeconds), else the specified batch command will be invoked.

2) command=A Batch command to be invoked if the specified file remains a constant size for the specified interval (intervalInSeconds).

3) intervalInSeconds=An integer value of the number of seconds between executions of checking the file for growth.

### A Batch File to Start NoGrowthResponder

A batch file (.BAT) may be created to call the Java application and to specify a log file for piping of the output messages. In this example, the existing log file is copied to previous.log and erased before creating the new log file.

Exemplary IBMLogFileMonitor.bat contents are:

If exist IBMLogFileMonitor.log copy /y IBMLogFileMonitor.log
IBMLogFileMonitor.previous.log
If exist IBMLogFileMonitor.log erase IBMLogFileMonitor.log
java NoGrowthResponder IBMLogFileMonitor.properties >>IBMLogFileMonitor.log

After creation of the batch file, it should be tested from a command window. The execution can be stopped using the Ctrl-c key combination.

A Batch File to Invoke when the Monitored File does not Grow as Expected

A batch file (.BAT) must exist for NoGrowthResponder to invoke in response to detecting no file growth in the expected interval. RestartIBMBridgeService.bat , as indicated below, is an example that stops and starts a Windows service. RestartIBMBridgeService.bat also pipes the output to create a log of its own.

Exemplary RestartIBMBridgeService.bat contents include:

ECHO %DATE% %TIME% :
RestartIBMBridgeService started. >>
RestartIBMBridgeService.log
NET STOP “IBM Bridge Service” >> RestartIBMBridgeService.log
NET START “IBM Bridge Service” >> RestartIBMBridgeService.log
ECHO %DATE% %TIME% :
RestartIBMBridgeService ended. >>
RestartIBMBridgeService.log

### The Log File

Assuming that IBMLogFileMonitor.bat file is used as an example above to start the monitor, and a .properties file may be used that is similar to the following:

(See “The .properties File” above for details.)
file=C:/IBMProblemBridge/Bridge.log
command =RestartIBMBridgeService.bat
intervalInSeconds=60

The log file may appear as follows:

Mar. 23, 2007 01:05:10 PM: IBMLogFileMonitor application started.

### Mar. 23, 2007 01:05:10 PM

### Mar. 23, 2007 01:06:10 PM

### Mar. 23, 2007 01:07:10 PM

Mar. 23, 2007 01:08:10 PM: No Growth for 60 seconds . . . Command “RestartIBMBridgeService.bat” issued.

### Mar. 23, 2007 01:09:20 PM

In this case there was no growth of file C:/IBMProblemBridge/Bridge.log from 1:07 PM to 1:08 PM on Mar. 23, 2007. RestartIBMBridgeService.bat was invoked and took about 10 seconds to complete (hence the next monitor interval timestamp of 01:09:20 PM.) Notice that the monitor prints the date/time of each execution.

### Starting NoGrowthResponder

Windows Task Scheduler™ can be used to schedule the .BAT file to start NoGrowthResponder when the server starts. To start execution right away, Task Scheduler can be used to schedule the NoGrowthResponder to run just once, in the near-future when the user has are planned to be logged off of the server. If the application is not scheduled to run while the user has logged off, a command window may be launched to shut down and stop the application when the user logs off.) Within Task Scheduler, on the Settings tab, the user needs to remove the checkmark in the box indicating to “Stop the task if it runs for:”. This is because the application runs in an infinite loop, sleeping for the specified period (.properties file intervalInSeconds value) following each execution to examine the specified file's size.

Example Tasks are:

IBM Bridge Log Monitor (scheduled to start when the server is started)
IBM Bridge Log Monitor (scheduled to start in 5 minutes, following logoff.)

### Stopping NoGrowthResponder

If the task needs to be stopped for some reason, this can be accomplished via Task Scheduler or Terminal Services Manager (Processes tab.) Also, since the application reads the .properties file each execution cycle, the .properties file values may be altered to monitor a file that does not exist, call a batch file that does nothing, or to put the application to sleep until the next server reboot or longer, essentially disabling it.

### Performance Benchmarks

Since this application writes to the log file each execution cycle, performance can be measured by examining the log timestamps.

Note that the code and documentation presented above for “NoGrowthResponder” is for exemplary purposes only, and is not to be construed as limiting the scope and purpose of the invention as described herein.

Note also that the flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method for determining if a communication session between two entities is viable, the method comprising:
monitoring data traffic between a first entity and a second entity, wherein the data traffic is transmitted between the first entity and the second entity via a data bridge;
logging the data traffic between the first entity and the second entity in a data traffic log; and
in response to the data traffic log remaining a same size during a pre-determined period of time, automatically resetting the data bridge to re-enable data communication between the first entity and the second entity.

2. The method of claim 1, further comprising:
in response to the data traffic log expanding during the pre-determined period of time, allowing the data bridge to continue to function as currently configured; and
in response to the data traffic log shrinking during the pre-determined period of time, allowing the data bridge to continue to function as currently configured.

3. The method of claim 1, wherein the data bridge only transfers data that conforms with File Transfer Protocol (FTP).

4. The method of claim 1, wherein the first entity and the second entity are different software applications.

5. The method of claim 1, wherein the first entity and the second entity are different computer systems that are coupled by a network.

6. The method of claim 1, wherein the first entity is a service provider and the second entity is a service customer.

7. The method of claim 1, wherein the pre-determined period of time is between one and five minutes.

8. A system comprising:
a data bridge that couples a first entity to a second entity;
a data traffic monitor coupled to the data bridge, wherein the data traffic monitor comprises a data traffic log of data traffic through the data bridge between the first entity and the second; and
a data bridge reset logic coupled to the data traffic monitor, wherein, in response to the data traffic log remaining a same size during a predetermined period of time, the data bridge reset logic automatically resets the data bridge.

9. The system of claim 8, wherein the data bridge only transfers data that conforms with File Transfer Protocol (FTP).

10. The system of claim 8, wherein the first entity and the second entity are different software applications.

11. The system of claim 8, wherein the first entity and the second entity are different computer systems that are coupled by a network.

12. The system of claim 8, wherein the predetermined period of time is between one and five minutes.

13. A computer-readable medium encoded with a computer program, the computer program comprising computer executable instructions configured for:
monitoring data traffic between a first entity and a second entity, wherein the data traffic is transmitted between the first entity and the second entity via a data bridge;
logging the data traffic between the first entity and the second entity in a data traffic log; and
in response to the data traffic log remaining a same size during a pre-determined period of time, automatically resetting the data bridge.

14. The computer-readable medium of claim 13, wherein the computer executable instructions are further configured for:
in response to the data traffic log expanding during the pre-determined period of time, allowing the data bridge to continue to function as currently configured; and
in response to the data traffic log shrinking during the pre-determined period of time, allowing the data bridge to continue to function as currently configured.

15. The computer-readable medium of claim 13, wherein the data bridge only transfers data that conforms with File Transfer Protocol (FTP).

16. The computer-readable medium of claim 13, wherein the first entity and the second entity are different software applications.

17. The computer-readable medium of claim 13, wherein the first entity and the second entity are different computer systems that are coupled by a network.

18. The computer-readable medium of claim 13, wherein the first entity is a service provider and the second entity is a service customer.

19. The computer-readable medium of claim 13, wherein the computer-usable medium is a component of a remote server, and wherein the computer executable instructions are deployable to a local client computer from the remote server.

20. The computer-readable medium of claim 13, wherein the computer executable instructions are capable of being provided by a service provider to a customer on an on-demand basis.
